(19) United States
(12) Patent Application Publication
(10) Pub. No.: US 2026/0322705 A1
(43) Pub. Date: Oct. 15, 2026

(54) HANDLING MODEL ID IN AI/ML OPERATION IN NETWORK

(71) Applicant: SAMSUNG ELECTRONICS CO., LTD., Gyeonggi-do (KR)

(72) Inventors: Chadi KHIRALLAH, Chertsey (GB); Mahmoud WATFA, Chertsey (GB)

(21) Appl. No.: 19/483,871

(22) PCT Filed: Apr. 30, 2024
(86) PCT No.: PCT/KR2024/005827

§ 371 Date: Nov. 12, 2025

(30) Foreign Application Priority Data
May 12, 2023 (GB) 2307099.8
Mar. 28, 2024 (GB) 2404540.3

(51) Int. Cl. H04L 41/16

(52) U.S. Cl. CPC H04L 41/16

(57) ABSTRACT

The present disclosure relates to a 5G communication system or a 6G communication system for supporting higher data rates beyond a 4G communication system such as long term evolution (LTE). There is disclosed a method for managing, in a network, one or more artificial intelligence and/or machine learning (AIML) model and/or functionality identities (MFIDs) for identifying one or more corresponding AIML models and/or AIML functionalities. The method comprises: transmitting, by the network, to one or more user equipment (UEs), information for allowing the UE and/or the network to assign one or more MFIDs to one or more corresponding models and/or functionalities in a unique manner.

### TECHNICAL FIELD

Certain examples of the present disclosure provide one or more techniques for handling model Identification (ID) in Artificial Intelligence (AI)/Machine Learning (ML) operation in a communication network, for example a 3^{rd} Generation Partnership Project (3GPP) 5^{th} Generation (5G) New Radio (NR) network or 6^{th} Generation (6G) network.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

The above information is presented as background information only to assist with an understanding of the present disclosure. No determination has been made, and no assertion is made, as to whether any of the above might be applicable as prior art with regard to the present invention.

### DISCLOSURE OF INVENTION

### Solution to Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

The present disclosure is defined in the independent claims. Advantageous features are defined in the dependent claims. Embodiments or examples disclosed in the description and/or figures falling outside the scope of the claims are to be understood as examples useful for understanding the present disclosure.

In an embodiment, a method for managing, in a network, one or more artificial intelligence (AI) or machine learning (ML) model or functionality identities (MFIDs) for identifying at least one of one or more corresponding AI or ML models or AI or ML functionalities, the method comprising: transmitting, by the network, to one or more user equipment (UEs), information for allowing at least one of the UE or the network to assign one or more MFIDs to at least one of one or more corresponding models or functionalities in a unique manner. In a certain example, the information may comprise one or more MFIDs. In an embodiment, A network entity may be configured to perform the method.

Other aspects, advantages and salient features of the disclosure will become apparent to those skilled in the art from the following detailed description taken in conjunction with the accompanying drawings.

### BRIEF DESCRIPTION OF DRAWINGS

FIG. 1 illustrates an exemplary method for managing, in a network, one or more AI/ML model and/or functionality identities (MFIDs) for identifying one or more corresponding AI/ML models and/or AI/ML functionalities;

FIG. 2 is a first signal flow diagram illustrating various exemplary operations relating to managing one or more MFIDs;

FIG. 3 is a second signal flow diagram illustrating further exemplary operations relating to managing one or more MFIDs;

FIG. 4 is a third signal flow diagram illustrating a yet further exemplary operation relating to managing one or more MFIDs; and

FIG. 5 is a block diagram of an exemplary network entity that may be used in certain examples of the present disclosure.

### MODE FOR THE INVENTION

The following description of examples of the present disclosure, with reference to the accompanying drawings, is provided to assist in a comprehensive understanding of the present disclosure, as defined by the claims. The description includes various specific details to assist in that understanding but these are to be regarded as merely exemplary. Accordingly, those of ordinary skill in the art will recognize that various changes and modifications of the examples described herein can be made without departing from the scope of the disclosure.

The same or similar components may be designated by the same or similar reference numerals, although they may be illustrated in different drawings.

Detailed descriptions of techniques, structures, functions, operations or processes known in the art may be omitted for clarity and conciseness, and to avoid obscuring the subject matter of the present disclosure.

The terms and words used herein are not limited to the bibliographical or standard meanings, but, are merely used to enable a clear and consistent understanding of the disclosure.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects.

Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

Certain examples of the present disclosure provide one or more techniques for handling model ID in AI/ML operation in a communication network, for example a 3GPP 5G NR network. However, the skilled person will appreciate that the present disclosure is not limited to this example, and may be applied in any suitable system or standard, for example one or more existing and/or future generation wireless communication systems or standards, including any existing or future releases of the same standards specification, for example 3GPP 5G and/or 6G.

The functionality of the various network entities and other features disclosed herein may be applied to corresponding or equivalent entities or features in the same or any other suitable communication systems or standards. Corresponding or equivalent entities or features may be regarded as entities or features that perform the same or similar role, function or purpose within the network. For example, the functionality of a base station or the like (e.g. evolved Node B (eNB), next generation Node B (gNB), Node B (NB), RAN node, Next Generation-Radio Access Network (NG-RAN), access point, wireless point, transmission/reception point, central unit, distributed unit, radio unit, remote radio head, etc.) in the examples below may be applied to any other suitable type of entity performing RAN functions, and the functionality of a UE or the like (e.g. electronic device, user device, mobile station, subscriber station, customer premises equipment, terminal, remote terminal, wireless terminal, vehicle terminal, etc.) in the examples below may be applied to any other suitable type of device.

A particular network entity may be implemented as a network element on a dedicated hardware, as a software instance running on a dedicated hardware, and/or as a virtualised function instantiated on an appropriate platform, e.g. on a cloud infrastructure.

The skilled person will appreciate that the present disclosure is not limited to the specific examples disclosed herein. For example:
The techniques disclosed herein are not limited to 3GPP 5G.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements or entities may be added to the examples disclosed herein.
One or more non-essential elements or entities may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed and/or the order in which messages are transmitted may be modified, if possible, in alternative examples.
The techniques described herein may be applied in any suitable order or combination.

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor.

Herein, the following documents are referenced and the contents thereof are incorporated into the present disclosure:
[1] 3GPP RP-213599
[2] 3GPP TS 38.331
[3] 3GPP TS 36.331
[4] 3GPP TS 38.413
[5] RAN2 #121 Chairman notes
[6] RAN2 #121bis Chairman notes

Various acronyms, abbreviations and definitions used in the present disclosure are defined at the end of this description.

AI/ML is being used in a range of application domains across industry sectors. In mobile communications systems, conventional algorithms (e.g. speech recognition, image recognition, video processing) in mobile devices (e.g. smartphones, automotive, robots) are being increasingly replaced with AI/ML models to enable various applications.

3GPP Radio Access Network (RAN) working groups are studying AI/ML for NR Air interface and its use in a 3GPP system, for example to enhance mobility, User Equipment (UE) location, amongst other use cases [1].

The 5G system can support various types of AI/ML operations, including the following three defined in 3GPP TS 22.261:
AI/ML operation splitting between AI/ML endpoints

The AI/ML operation/model may be split into multiple parts, for example according to the current task and environment. The intention is to offload the computation-intensive, energy-intensive parts to network endpoints, and to leave the privacy-sensitive and delay-sensitive parts at the end device. The device executes the operation/model up to a specific part/layer and then sends the intermediate data to the network endpoint. The network endpoint executes the remaining parts/layers and feeds the inference results back to the device.
AI/ML model/data distribution and sharing over 5G system

Multi-functional mobile terminals may need to switch an AI/ML model, for example in response to task and environment variations. An assumption of adaptive model selection is that the models to be selected are available for the mobile device. However, since AI/ML models are becoming increasingly diverse, and with the limited storage resource in a UE, not all candidate AI/ML models may be pre-loaded on-board. Online model distribution (i.e. new model downloading) may be needed, in which an AI/ML model can be distributed from a Network (NW) endpoint to the devices when they need it to adapt to the changed AI/ML tasks and environments. For this purpose, the model performance at the UE may need to be monitored constantly.
Distributed/Federated Learning over 5G system

A cloud server may train a global model by aggregating local models partially-trained by each of a number of end devices (e.g. UEs). Within each training iteration, a UE performs the training based on a model downloaded from the AI server using local training data. Then the UE reports the interim training results to the cloud server, for example via 5G UL channels. The server aggregates the interim training results from the UEs and updates the global model. The updated global model is then distributed back to the UEs and the UEs can perform the training for the next iteration.

An AI/ML model may be identified by a Model ID.

The following are agreements on model ID in RAN2:
RAN2 #121 meeting:
⇒RAN2 assumes that Model ID is unique “globally”, e.g. in order to manage test certification each retrained version need to be identified.
RAN2 #121bis-e meeting:
⇒Model ID can be used to identify model or models for the following LCM purposes:
model selection/activation/deactivation/switching (or identification, if that will be supported as a separate step).
(e.g. for so called “model ID based LCM”)
⇒If model transfer/delivery is supported, model ID can be used for model transfer/delivery LCM purpose.
⇒How to achieve globality of the Model ID is FFS.
Initial discussion in RAN2: the following global unique model ID definition directions can be considered as a starting point:
Direction1: Pre-defined/hard-coded global unique model ID
Direction3: Assigned global unique model ID via specific ID management node.
Note: Other global unique model ID definition is not precluded.
Model ID structure, if any, is FFS

In the techniques of the related art, for example those referred to above, there occur the following problem(s).

The behaviour of the UE and network in relation to AI/ML model ID allocation and handling of model ID is not clear. The following problems require solutions.
1) How to allocate model ID for UE-side model(s), UE-part of two-sided model(s), network-side model(s), and/or network-part of two-sided model(s)?
2) How to handle model IDs exchange, modification, release, and/or other actions related to model lifecycle management (LCM) and model transfer/delivery.
3) Other open points.

Certain examples of the present disclosure provide one or more solutions to address the above problems.

Certain examples of the present disclosure provide a method for managing, in a network (or a network entity), one or more artificial intelligence (AI) and/or machine learning (AI/ML) model and/or functionality identities (MFIDs) for identifying one or more corresponding AI/ML models and/or AI/ML functionalities, the method comprising: transmitting, by the network, to one or more user equipment (UEs), information for allowing the UE and/or the network to assign one or more MFIDs to one or more corresponding models and/or functionalities in a unique manner, wherein the information comprises one or more MFIDs.

In certain examples, one or more of the models may comprise one or more of: a network-side model; a network-part of a two-sided model; a UE-side model; and a UE-part of a two-sided model.

In certain examples, the information may comprise one or more of: a list of allocated MFIDs (e.g. for network-side, network-part, UE-side and/or UE-part models); and a list of not allocated (e.g. available) MFIDs.

In certain examples, the method may further comprise allocating, by the network and/or the UE, one or more MFIDs to one or more corresponding models and/or functionalities in a unique manner based on the information.

In certain examples, allocating the MFIDs in a unique manner may comprise uniquely assigning one or more MFIDs to one or more models and/or functionalities: globally; within a certain validity area (e.g. cell, tracking area, slice and/or country); and/or within an Access and Mobility Management Function (AMF).

In certain examples, at least one MFID may be allocated to one or more of: a network-side model and/or functionality; a network-part of a two-sided model and/or functionality; a UE-side model and/or functionality; and a UE-part of a two-sided model and/or functionality.

In certain examples, the allocating may be performed at least partly by an Access and Mobility Management Function (AMF) entity (e.g. based on an indication from a Radio Access Network (RAN) entity).

In certain examples, the method may further comprise: selecting, by the UE, one or more MFIDs based on the information; and allocating the selected MFIDs to one or more models and/or functionalities.

In certain examples, the method may further comprise transmitting, by the UE, to the network, an indication of the MFIDs allocated by the UE and/or MFID not allocated by the UE.

In certain examples, the allocating may comprise allocating certain MFIDs (e.g. one or more set MFIDs and/or one or more set MFID ranges) only to one or more of: a predetermined service; a predetermined functionality; a predetermined use case; a predetermined configuration; a predetermined scenario; and a predetermined site.

In certain examples, the method may further comprise rejecting, by one of the network and the UE, the allocation of an MFID to a model and/or functionality by the other of the network and the UE.

In certain examples, the information and/or related information may be provided via one or more of: RRC signalling/messages; NAS signalling/messages; and one or more Information Elements (IEs).

In certain examples, the information may further comprise information relating to the MFIDs.

In certain examples, the related information may comprise one or more of: an MFID type (e.g. global, dynamic, temporary and/or local); and an MFID side (e.g. UE-side, UE part, network-side and/or network part).

In certain examples, the method may further comprise transmitting, by the network to a UE and/or by a UE to the network, information indicating support or lack of support for MFID type.

In certain examples, the method may further comprise storing the information and/or related information.

In certain examples, the information may be stored in one or more of: a RAN entity; a UE context; and an AMF entity.

In certain examples, the method may further comprise transmitting, by a first RAN, to a second RAN, the information and/or related information (e.g. during handover of a UE).

In certain examples, the information may comprise one or more ranges of MFIDs.

In certain examples, the method may further comprise transmitting, by the network, to the one or more UEs, updated information for allowing the UE and/or the network to assign one or more MFIDs to one or more corresponding models and/or functionalities in a unique manner, and the updated information may comprise one or more MFIDs.

In certain examples, the method may further comprise updating, by a UE and/or the network, the allocation of one or more MFIDs to one or more corresponding models and/or functionalities based on the updated information.

In certain examples, transmitting the information may comprise transmitting an MFID to a group of two or more UEs, and the MFID may be based on a combination of a group ID component and a group MFID component.

In certain examples, the group ID may be associated with the group of UEs and is unique, and the group MFID may be unique within the group of UEs.

In certain examples, the information may be transmitted as part of one or more of: a model transfer and/or delivery procedure; and a model life cycle management procedure.

In certain examples, one or more of the MFIDs may be associated with a priority level.

In certain examples, the method may further comprise performing, by the UE and/or the network, an AI/ML function using a model based on the priority level of the corresponding MFID.

In certain examples, the UE and/or the network may assign an MFID to a model and/or functionality based on the priority level of the MFID.

In certain examples, the method may further comprise requesting, by the network and/or a UE, release of one or more MFIDs at the UE and/or the network.

In certain examples, the method may further comprise releasing at least one MFID in response to the request (e.g. as part of the deactivation procedure of the model).

In certain examples, the method may further comprise determining not to release a requested MFID in response to the request.

In certain examples, the method may further comprise transmitting, by the UE and/or the network, a message comprising information on the status (e.g. released, not released) of the one or more MFIDs requested to be released.

In certain examples the one or more AI/ML functionalities may comprise one or more functionalities and/or part of functionality associated with one or more AI/ML models and/or part of an AI/ML model.

In certain examples, the one or more AI/ML functionalities may comprise one or more functionalities and/or part of functionality associated with AI/ML LCM.

In certain examples: one or more of the models may be each associated with one or more functionalities and/or part of functionality, one or more of the functionalities and/or part of functionality my be each associated with one or more models, one or more of the models may not be associated with any of the functionalities and/or part of functionality, and/or one or more of the functionalities and/or part of functionality may not be associated with any of the models.

Certain examples of the present disclosure provide a network entity (e.g. AMF or RAN) configured to perform a method according to any example, aspect, embodiment and/or claim disclosed herein.

Certain examples of the present disclosure provide a network (or wireless communication system) comprising one or more network entities (e.g. UE, RAN, AMF) according to any examples, aspects, embodiments and/or claims disclosed herein.

Certain examples of the present disclosure provide a computer program comprising instructions which, when the program is executed by a computer or processor, cause the computer or processor to carry out a method according to any example, aspect, embodiment and/or claim disclosed herein.

Certain examples of the present disclosure provide a computer or processor-readable data carrier having stored thereon a computer program according to any example, aspect, embodiment and/or claim disclosed herein.

Various specific examples will now be described in more detail.

Although the solutions described herein are described in relation to handling Model ID, the skilled person will appreciate that the same or similar solutions can be used for handling identification of a model using functionality/functionalities or functionality ID, etc. That is, the same or similar solutions can be used for handling AI/ML functionality/functionalities ID(s) of related AI/ML model(s) and/or handling functionality/functionalities AI/ML LCM purposes. Additionally, the same or similar solutions can be used for handling functionality and functionality identification in AI/ML operations and/or LCM purposes.

The skilled person will appreciate that a model, or multiple models, may be related to, or part of, one functionality, or multiple functionalities. The techniques disclosed herein may be applied to any suitable relationship between models and functionalities.

The skilled person will also appreciate that the techniques disclosed herein may be applied to at least one of: network-side models, network-part of two-sided models, UE-side models, or UE-part of two-sided models.

The skilled person will also appreciate that the techniques disclosed herein may be applied to a single UE or a group of UEs.

The skilled person will appreciate that the proposals disclosed herein may be applied using any suitable type of messages, for example Radio Resource Control (RRC) message, Non Access Stratum (NAS) message, or any combination of RRC and NAS messages.

### Allocation of Model ID

In certain examples of the present disclosure, coordination of model IDs between the network (e.g., a network entity included in a core network such as an AMF entity, or a network entity included in a RAN such as a base station) and the UE (or a group of UEs) is provided to ensure unique (or harmonised) allocation of models IDs for the UE (or a group of UEs).

In certain examples, for network-side and/or network-part of two-sided models, the network may assign a model ID (or models IDs) for those models.

The network may update model IDs allocated to different UEs upon any change in the network, for example changes in network conditions and/or allocated models (model side, or model LCM purposes, etc.). For example, changes may include: a model(s) is no longer active at a given UE (or group of UEs) in a given time period or location/area; or the network decides to stop using a model or the priority of the model changes (e.g. becomes low priority). The network may need to release this ID(s), for example as part of model(s) deactivation.

In certain examples, the network may assign a model (or models) an ID (or IDs) that is (are) valid (or active) for/in a given cell, tracking area, slice, country, any other area.

In a related example, the model ID assigned for a given cell, tracking area, slice, country, any other area, should be uniquely assigned for the validity area. For example, for a model ID for which the validity area is a tracking area, the assigned model ID should be uniquely assigned over all cells of the tracking area. That is, upon the UE mobility, within the same tracking area, the model ID remains unique over all cells in this tracking area. Upon UE mobility to a cell in a new tracking area (i.e. different to an old tracking area, in which the model ID is unique), this UE will not be allowed to keep the same model ID (assigned in the old tracking area) for use over cells in the new tracking area. Hence, the model ID should be released (not active any more) upon the UE movement to a cell in the new tracking area. Additionally, a new unique (on the level of tracking area) model ID should be allocated to the model for use in the new tracking area.

In certain examples, the model ID should be unique within a global cell ID and/or a new target cell. For example, the model ID may be unique globally.

In certain examples, for network-side and/or network-part of two-sided models, the network may provide (or transmit) a list of model IDs to the UE (or group of UEs). In some examples, the list may indicate (or include or comprise) the list of assigned (allocated) model IDs and/or list of available (or not-assigned, not-allocated) model IDs for the UE (or group of UEs). In other examples, the network may also provide the list of model IDs allocated to network-side model(s) and/or network-part of two-sided model(s).

In an embodiment, the network provides (or indicates) to the UE (or group of UEs) information related to the model ID(s), e.g. the model ID type (global, local, dynamic, temporary, and/or any mix of the previous, etc.), and/or model side (UE-side, UE-part, network side, network part). Optionally, this information may be included in the list of model IDs, e.g. may be in the form of a new Information Element (IE), and/or RRC and/or NAS message/signalling, or sent in a separate IE (and/or RRC and/or NAS message/signalling). For example, this information may be transmitted via a RRC message, between a network entity in a RAN and the UE, or via NAS message, between a network entity in a core network and the UE.

For example, the indication may be a new defined Model ID Type IE, where this IE may have a new defined value that may indicate a type of corresponding model ID. For example, the Model ID Type IE may have a value that can be set to “Global”, “Dynamic”, “temporary” or “local”, or any combination thereof, etc.

The network may configure the Model ID Type, as global, dynamic, temporary, local, etc., depending on the AI/ML LCM purposes, model meta data, use case, model functionality, and/or other assistance information from the network and/or the UE.

The UE and/or the network (e.g. NG-RAN, gNB, or a base station) may configure the model ID, for a model (or models) or any model side (e.g. UE-side, network-side, UE-part, and/or Network-part) to be a locally unique model ID. For example, the rule/range of locality may be defined in a given area (or location), such as cell-level, slice-level, tracking area-level, country-level, and/or other area types.

The network and UE may exchange indications of their support of allocating/assigning different type of model IDs for different model-side models. For example, the network and the UE may exchange indications of their support of allocating model types such as global, dynamic, temporary, local, etc. The network and the UE may indicate, to each other, that they may allocate model ID to a UE-side AI/ML model, a network-side AI/ML model, a UE-part of two-side AI/ML model, and/or a Network-part of two-side AI/ML model.

In certain examples, the network may indicate its support of (allocation of) different types of IDs, at least to network-side and/or network-part models, using RRC and/or NAS signalling/messages, and/or via system information broadcast (e.g. periodically and/or on demand). The UE may indicate its support of allocation of different type of IDs, at least to UE-side and/or UE-part model(s), using capability reporting.

In certain examples, the network indication of support of different type of IDs may act as an implicit indication to the UE to report it is capability to handle (or assign) different types of IDs, at least to UE-side and/or UE-part of two-sided models.

In certain examples, the list of model IDs associated/allocated to a given UE models (e.g. to be assigned to UE-side model(s) and/or UE-part of two-sided model(s)), may be stored in the UE context. For example, as part of the UE context management procedures (and/or any other procedure).

In certain examples, the list of model IDs may contain IDs assigned to models, e.g. available at the UE and/or the network, and IDs not yet assigned to any model(s).

In certain examples, the list of model IDs may include model IDs already assigned to network-side model(s) and/or network-part of two-sided model(s).

In certain examples, the list of model IDs may include a range of model IDs available to a given UE to use in assigning IDs to AI/ML models (e.g. models deployed at the UE and/or network).

The UE (or group of UEs) may store the list of model IDs.

In certain examples, the UE (or group of UEs) may update (e.g. overwrite) the list of model IDs, stored in the UE, or the UE context, with the newer (or latest, or updated, or modified) list of model IDs. In certain examples, the updated list of model IDs may be received from an internal network entity (and/or function) or an external entity (and/or function), a server, an Operations Administration and Maintenance (OAM), Application, a network operator, based on a country policies and rules, a third party, or another UE (or a group of other UEs), etc.

In certain examples, the network stores the list of model IDs.

In certain examples, the network may update (e.g. overwrite) the list of model IDs, stored in the network with the newer (or latest, or updated, or modified) list of model IDs. In certain example, the updated list of mode IDs may be received from an internal network entity (and/or function) or an external entity (and/or function), a server, an Operations Administration and Maintenance (OAM), an Application, a network operator, based on a country policies and rules, a third party, or the UE (or a group of UEs), etc.

For UE-side models and/or UE-part of two-sided models, the network may provide a list of model IDs (available) to the UE (or group of UEs). In certain examples, the UE (or group of UEs) may use the list of model IDs, received from the network, to assign IDs to a UE-side and/or UE-part of two-sided models.

In certain examples, for UE-side models and/or UE-part of two-sided models, the UE may provide a list of model IDs to the network. In some examples, the list of model IDs may indicate assigned model IDs and/or not-assigned (available) model IDs.

In other examples, both the UE and the network may allocate a model ID for two-sided models. In some examples, the UE may assign the model ID (or part of model ID) for the UE-part of the two-sided model, and the network may assign the model ID (or part of the model ID) for the network-part of two-sided mode. Both the UE and the Network may indicate the allocated model ID (or part of model ID) to each other.

In certain examples, the network is responsible for allocating the model IDs for all models, that is, including UE-side, network side and two-sided models. In a related example, the network may indicate to the UE the list of network-assigned or not-assigned (available) models IDs.

In other examples, the UE (or group of UEs) is (are) responsible for allocating the model IDs for all models, that is, including UE-side, network side and two-sided models. In a related example, the network may indicate to the UE the list of network-assigned or not-assigned (available) models IDs.

In certain examples, the model ID for group of UEs may have a group ID component and a group-model ID component. The group ID component may indicate the corresponding group of UEs. The group-model Id component may indicate the assigned model ID. The group-model ID component may be unique within a group ID component and the group ID may also be unique.

In certain examples, the network allocation (or an allocation by the network) of the model ID (or models IDs) to UE-side and/or UE-part models is part of the model transfer/delivery procedure to the UE. For example, the network may assign a model ID to a certain model during a transfer procedure or a delivery procedure of the model to the UE.

In certain examples, the network allocation of the model ID (or models IDs) to UE-side and/or UE-part models is part of the model LCM procedure. In some examples, the allocation of the model ID (or models IDs) may be part of the activation of the model (or models). For example, the network may assign a model ID to a certain model during an activation/deactivation procedure of the model, a switching procedure of the model to another model, a selection procedure of the model, or an identification procedure of the model.

The network and/or the UE may assign specific ID(s) (or a range of ID(s)) for a given set of services, functionality/functionalities, use cases, configurations, scenarios, sites, etc., for example, assign a specific model ID(s) for public safety.

In certain examples, at least one model ID may be reserved for special services, for example network operations, public safety, or other special applications that may be defined, or for a group of UEs. As such, the network and/or UE should ensure that any ID from this reserved set should only be associated with the application or service for which it is reserved. Otherwise the model ID should not be allocated or used. As such, the UE or the network should attempt to enforce this and optionally reject any model ID which is not in accordance to this rule or policy.

The network may configure the UE behaviour to handle the model ID(s) for its models, for example, select model ID(s), assign, modify, release or discard, or indicate model ID(s), etc.

A model ID may explicitly or implicitly be associated with a priority level. In this case, the allocation and/or use of a model ID may lead to prioritization of the AI/ML function that is associated with the model ID. The UE or network may then perform prioritized AI/ML functions based on the priority level of the model ID. The priority level may be explicitly signalled or exchanged between the network and the UE, or may be pre-defined for specific model IDs (e.g. reserved IDs) or for specific AI/ML applications.

In one example, the list of model IDs (or range of model IDs) is pre-configured by the network, external entity, server, Operations Administration and Maintenance (OAM), Application, network operator, based on a country policies and rules, third party, etc. For example, a model ID may be pre-defined or hard-coded to be unique globally by a network entity, an external network entity, a server, or a third-party entity.

In certain examples, in the case of large number of models or number of models is larger than the range of model IDs, available for UE-side, network-side and/or two-sided models, the network and/or the UE (or group of UEs) may select a model ID, for example, randomly from the range of available model IDs. Both the UE and the network would then indicate to the other side the selected model ID(s).

In certain examples, if selecting a model ID randomly and both the UE and network selects the same ID, the priority of keeping the ID is given for the network. In other examples, the priority of keeping the ID is given for the network at least for the allocation of the ID for the network-side and/or network-part of two-sided model(s). In another example, the priority of keeping the ID is given for the UE at least for the allocation of the ID for the UE-side and/or UE-part of two sided model(s).

In certain examples, the model ID is considered to be unique within an Access and Mobility Management (AMF), where the AMF may be identified by any of the following identities (for example as defined in 3GPP TS 23.003): AMF identifier, AMF Region ID, AMF Set ID, AMF Pointer.

The AMF (where the AMF may be identified for example by any of the identities listed above) may assign a model ID based on an indication from the RAN entity. For example, as part of any existing (or newly defined) NG (N2) signalling and/or messages, and/or IEs, the RAN (e.g. gNB or NG-RAN) may request the assignment of at least one model ID, or in another example, a list of model IDs. For example, the RAN request of the model ID (or list of model IDs) may be as part of any existing (or newly defined) NG signalling/messages and/or IEs. The AMF may assign at least one model ID based on an explicit request from the RAN entity (e.g. NG-RAN, gNB), or in another example, a list of model IDs. Alternatively, the AMF may assign at least one model ID based on subscription information for a UE or a group of UEs. The indication from the RAN may also be associated with an indication for an assignment which is for a single UE or a group of UEs, where alternatively the AMF may have this information e.g. based on local policies or configurations or subscription information. Alternatively, the AMF may not assign a model ID (or list of model IDs), based on assistance information from another network entity (and/or function). For example, assistance information may include analytics or predictions, statistics (e.g. from Network Data Analytics Function (NWDAF)), and/or history of previously assigned model ID (or list of model IDs).

The AMF may store any model ID that is being used by the RAN. For example, the AMF may do so during the release of the UE's NAS and/or RRC connection. For example, during the UE context release request (e.g. when the RAN sends the UE CONTEXT RELEASE REQUEST message) the RAN may indicate the list of model IDs that the UE is using and may request the AMF to store the model ID(s). The AMF may store the model ID(s) every time the UE's connection is released or when the RAN explicitly requests the AMF to do so, or based on other local policies. This technique may also be applied when the UE's context is being suspended, for example when the RAN sends the UE CONTEXT SUSPEND REQUEST message to the AMF.

The RAN may fetch a stored UE context, where the context may be for AI/ML which includes at least a model ID. The term “model ID” may be used to refer to model IE and/or other AI/ML related parameters that may also be used with or associated with a model ID. This may also include a priority level which may be associated with the model ID.

The RAN may get the model ID from the AMF when a UE enters RRC-CONNECTED state from any state, or when the UE establishes an RRC connection optionally which requires sending a NAS message to the AMF.

In some examples, the RAN may explicitly request the model ID that is/are stored at the AMF. In other examples, the AMF may provide the model ID of the UE to the RAN. The AMF may do so when the UE establishes a NAS signalling connection and the AMF then sends the model ID to the RAN using any NG Application Protocol (NGAP) message or any N2 protocol message. For example, the AMF may send any stored model ID—for a UE in question—to the RAN using the Initial UE Context Setup Request message (or any other message, for example the UE CONTEXT MODIFICATION REQUEST message, or UE CONTEXT SUSPEND RESPONSE message). The AMF may do so if the AMF has policies to send this information or if the subscription information requires so or if the AMF has previously stored model ID(s) for the UE or if the AMF receives an explicit request from the RAN to get the model ID(s) for the UE.

A model ID may be sent from the source RAN entity (e.g. NG-RAN, gNB) to another target RAN entity (e.g. NG-RAN, gNB) during handover of the UE. This may be done directly via the signalling between the RAN entities or via the AMF. In the case of the handover being done using Xn signalling (and messages and IEs) between the RAN entities, when the target RAN entity informs the AMF about handover completion, the AMF may decide to modify (allocate, release, update) a model ID and provide it to the target RAN entity. During handover, the source RAN entity may provide the model ID to the target RAN entity.

The skilled person will appreciate that the names of the proposed new IEs (and/or messages) described herein are merely non-limiting examples, and any other suitable names may be used instead.

### Handling of Model IDs Between the UE and the Network

In certain examples, the network (e.g., a network entity included in a core network such as an AMF entity, or a network entity included in a RAN such as a base station) may send the list of model IDs to a give UE (or group of UEs) using an existing and/or newly defined message (e.g. RRC and/or NAS signalling/messages). For example, Model ID List IE (Range=1 . . . <maxnoofModel>) may be included in a request message (or be used as a newly defined message).

In a related example, the UE (or group of UEs) may allocate (or assign) a model ID (or models IDs) from the list of model IDs, received from the network, and include those model IDs in an Acknowledge or Confirm message (and/or existing or newly defined IEs) back to the network. For example, the UE (or group of UEs) may transmit a message indicating that the model ID (or model IDs) are allocated (or assigned) using an existing and/or newly defined message (e.g. RRC signalling/messages, NAS signalling/messages).

In certain examples, the UE (or group of UEs) may reject (or not use) all IDs (or part of the IDs) included in the list of model IDs, received form the network, for assigning IDs to UE-side and/or UE-part models. In a related example, the UE may indicate to the network, for example in a failure message, the IDs, as rejected IDs, allocated IDs, assigned IDs, not-assigned (or available) IDs, etc. The rejection (or failure) message may be sent in an existing and/or newly defined message (e.g. via RRC and/or NAS signalling, messages) and/or IEs. In certain examples, the UE (or group of UEs) may indicate to the network the reject (or failure) reason using an existing cause value or a newly defined cause value. For example, “NotSuitableModelID”, “NotSupportedModelID”, “NotAllowedModelID”, or any other naming.

In certain examples, the model IDs may be released (e.g. un-assigned or not-assigned or de-allocated) by the network and/or the UE (or group of UEs), for example upon deactivation of a model (or models) and/or switching of the model (or models), for example to a different model (or models).

In certain examples, the network may release (e.g. un-assigned or not-assigned or de-allocated) a model ID (or models IDs) of UE-side and/or UE-part models. In one example, the release of the model ID (or models IDs) may be part of the deactivation procedure of the model (or models).

In certain examples, the network may request the UE (or group of UEs) to release a model ID (or models IDs) of UE-side and/or UE-part models. This request may be sent in an existing and/or newly defined message (e.g. via RRC signalling/messages and/or NAS signalling/messages) and/or IEs. In a related example, the UE may acknowledge (or confirm) to the network the release of the desired model ID (or model IDs). In other examples, the UE may send to the network a list of model IDs, or example including released, failed to release (or reject release), currently allocated, and/or available (not-allocated) model IDs at the UE (or group of UEs) side.

In certain examples, the UE (or group of UEs) may reject the release of model ID (or models IDs) of UE-side and/or UE-part models, indicated in network request (message). In a related example, this rejection (or failure) message may be sent in an existing and/or newly defined message (e.g. via RRC signalling/messages and/or NAS signalling/messages). In certain examples, the UE (or group of UEs) may indicate to the network the reject (or failure) reason for releasing the model ID (or models IDs) using an existing cause value or a newly defined cause value for example “NoReleaseOfModelIDAllowed”, “ReleaseOfModelIDNotSupported”, or any other naming.

In certain examples, the network may modify (or update) the list of model IDs, previously shared with the UE (or group of UEs). In a related example, the network may share the list with the UE (or group of the UEs) involved in AI/ML operations.

In certain examples, the network may send the modified list of model IDs, for example in a newly defined IE, for example Modified Model ID List IE (or any other suitable naming).

In certain examples, the UE may overwrite the content of previously received list of model IDs (e.g. Model ID List IE) with the modified list of model IDs (e.g. Modified Model ID List IE).

In certain examples, the UE (or group of UEs) may reject the model ID (or models IDs) allocated by the network for UE-side and/or UE-part of two-sided models. In certain examples, the UE may provide a cause value for the rejection (or failure) of the model ID (or models IDs), for example “AllocatedModelIDNotSupported”, “NotSupportedModelID”, or any other suitable naming.

The skilled person will appreciate that the names of the proposed new IEs (and/or messages) described herein are merely non-limiting examples, and any other suitable names may be used instead.

### Examples of Changes to 3GPP Specifications

### RRC Specifications:

The model information (e.g. parameters, meta data, other model related information) may be provided using existing System Information Blocks (SIBs), and/or a new SIB. For example, the IE SystemInformationBlockTypeXX contains model assistance information that is used to signal information related to the model between the network and the UE. The IE SystemInformationBlockTypeXX may include a field modelInfoList. The field modelInfoList may indicate (or comprise) model ID(s) and information associated with each AI or ML model. For example, the field modelInfoList may comprise a field modelID and a field modelInfo. The field modelID may indicate an allocated model ID for each model. The field modelInfo may indicate information associated with each model, for example, parameter(s) of corresponding model, meta data of corresponding model, or other model related information. The field modelParameters may indicate one or more parameters of the corresponding AI/ML model. Table 1 may show an exemplary structure of the IE SystemInformationBlockTypeXX.

TABLE 1
SystemInformationBlockTypeXX information element

-- ASN1START
SystemInformationBlockTypeXX-rXX ::= SEQUENCE {

| | | |
|---|---|---|
| modelInfoList-r17 | ModelInfoList-rXX | OPTIONAL, -- Need OR |
| lateNonCriticalExtension | OCTET STRING | OPTIONAL, |

...
}

| | |
|---|---|
| ModelInfoList-rXX ::= | SEQUENCE (SIZE (1..maxModel-rxx)) OF ModelInfo-rXX |
| ModelInfo-rXX ::= | SEQUENCE { |
| modelId-rXX | INTEGER (0..XXX), |
| modelInfo-rXX | SEQUENCE { |

```
    modelParameters-rXX ModelParameters-rXX OPTIONAL, -- Need OR
    ...
    },
  Other model related parameters...
}
-- ASN1STOP
```

### Other 3GPP Spec

Option 1: Model ID List Include UE-Side and/or UE-Part IDs

### Model ID List

The network may send to the UE (or group of UEs), the IE below that contains a list of allocated and/or available model IDs for UE-side models and UE-part of two-sided models. Table 2 may show exemplary fields (IEs) included in the IE Model ID List. Table 3 may show a brief description for a range bound maxnoofModel.

TABLE 2

| IE/Group | | | IE type and | | | Assigned |
|---|---|---|---|---|---|---|
| Name | Presence | Range | reference | Semantics description | Criticality | Criticality |
| Model ID List | | 1 . . . | | | — | |
| | | <maxnoofModels> | | | | |
| >Allocated | M | | x.x.x.x | Contains information of | — | |
| Model ID List | | | | the allocated model IDs | | |
| | | | | for UE-side and/or UE- | | |
| | | | | part of two-sided models. | | |
| >Available | M | | x.x.x.x | Contains information of | — | |
| Model ID List | | | | the available model IDs | | |
| | | | | for UE-side and/or UE- | | |
| | | | | part of two-sided models. | | |
| >Other | O | | x.x.x.x. | | YES | ignore |
| Information | | | | | | |
| related to | | | | | | |
| Model ID | | | | | | |

TABLE 3

| Range bound | Explanation |
|---|---|
| maxnoofModels | Maximum no. of Models allowed for a UE. Value |
| | is xx. |

### Option 2: Model ID List Include all Model IDs

### Model ID List

The network may send to the UE (or group of UEs), the IE below that contains a list of allocated and/or available model IDs for UE-side models, UE-part of two-sided models, network side models, and/or network side or two-sided models. Table 4 may show exemplary fields (IEs) included in the IE Model ID List. Table 5 may show a brief description for range bounds included in the Table 4.

TABLE 4

| IE/Group | | | IE type and | | | Assigned |
|---|---|---|---|---|---|---|
| Name | Presence | Range | reference | Semantics description | Criticality | Criticality |
| Model ID List | | 1 . . . | | | — | |
| | | <maxnoofModels> | | | | |
| >Allocated | M | | x.x.x.x | Contains information of | — | |
| Model ID List | | | | the allocated model IDs. | | |
| >> Allocated | | | | Model IDs allocated to | | |
| Model ID List | | | | UE-side and/or UE-part | | |
| for UE-side | | | | of two-sided models. | | |
| and/or UE- | | | | | | |
| part models | | | | | | |
| >> Allocated | M | | x.x.x.x | Model IDs allocated to | — | |
| Model ID List | | | | network-side and/or | | |
| for network- | | | | network-part of two- | | |
| side and/or | | | | sided models. | | |
| network-part | | | | | | |
| models | | | | | | |
| >Not | | | | Contains information of | | |
| Allocated | | | | the not allocated | | |
| Model ID List | | | | (available) model IDs. | | |
| >Other | O | | x.x.x.x. | | YES | ignore |
| Information | | | | | | |
| related to | | | | | | |
| Model ID List | | | | | | |

TABLE 5

| Range bound | Explanation |
|---|---|
| maxnoofModels | Maximum no. of models allowed in the |
| | network. Value is xx. |
| maxnoofModelforUE | Maximum no. of models allowed for a given |
| | UE including UE-side and/or UE-part of |
| | two-sided models. Value is xx. |
| maxnoofModelforNetwork | Maximum no. of models allowed for the |
| | network including network-side and/or |
| | network-part of two-sided models. |
| | Value is xx. |

### Example Methods/Signal Flows

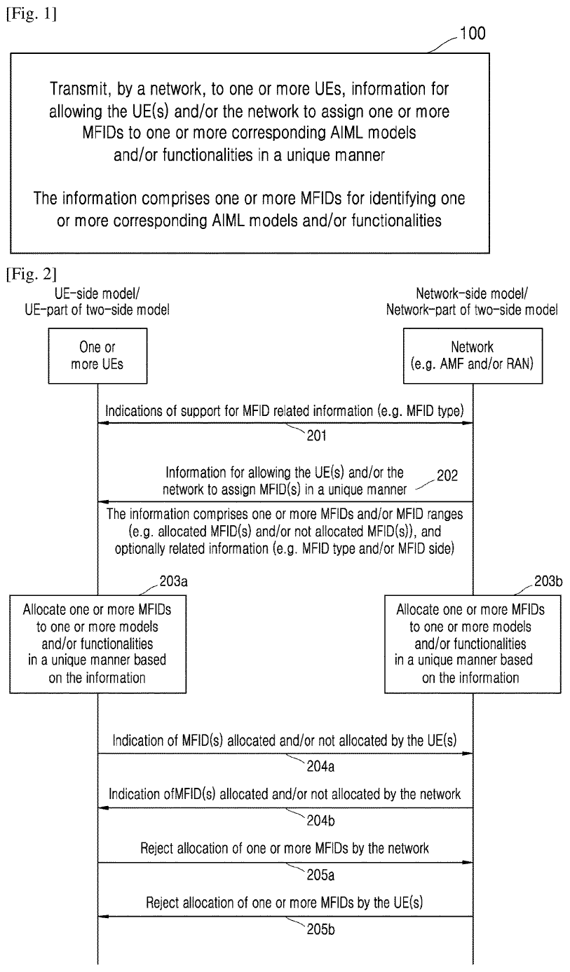

FIG. 1 illustrates an exemplary method for managing, in a network, one or more AI/ML model and/or functionality identities (MFIDs) for identifying one or more corresponding AI/ML models and/or AI/ML functionalities.

Referring to FIG. 1, operation 100 comprises transmitting, by a network, to one or more UEs, information for allowing the UE(s) and/or the network to assign one or more MFIDs to one or more corresponding models and/or functionalities in a unique manner. The information comprises one or more MFIDs for identifying one or more corresponding AI/ML models and/or AI/ML functionalities.

FIG. 2 is a first signal flow diagram illustrating various exemplary operations relating to managing one or more MFIDs.

Referring to FIG. 2, in a first operation 201, the network (e.g. AMF, RAN and/or other network entity, such as a base station) and one or more UEs exchange messages with each other. The messages include indications of support for MFID related information (e.g. MFID type, or model type related to the MFID).

In a second operation 202, the network transmits a message to the UE(s). The message includes information for allowing the UE(s) and/or the network to assign one or more MFIDs in a unique manner. The information includes one or more MFIDs and/or MFID ranges (e.g. allocated MFID(s) and/or not allocated MFID(s)), and optionally related information (e.g. MFID type and/or MFID side information).

In a third operation 203a, the UE(s) allocate(s) one or more MFIDs to one or more models and/or functionalities in unique manner based on the information. For example, the UE may assign a first model ID to a first model, or assign a first functionality ID to a first functionality of the first model. For example, the first model ID and the first functionality ID being unique globally or locally. Similarly, in operation 203b, the network allocates one or more MFIDs to one or more models and/or functionalities in a unique manner based on the information. For example, the network (e.g., an AMF entity or a base station) may assign a second model ID to a second model, or assign a second functionality ID to a second functionality of the first model, the second model ID and the second functionality ID being unique globally or locally. For example, the network may assign the first model ID or the first functionality ID, instead of the UE.

In an embodiment, the UE(s) may allocate MFIDs to UE-side AI/ML models or UE-part of two-sided AI/ML models. The network may allocate MFIDs to network-side AI/ML models or network-part of two-sided AI/ML models. Alternatively or additionally, the network may allocate MFIDs to UE-side AI/ML models or UE-part of two-sided AI/ML models. Alternatively or additionally, the UE(s) may allocate MFIDs to network-side AI/ML models or network-part of two-sided AI/ML models.

In a fourth operation 204a, the UE(s) transmit(s) a message to the network. The message includes an indication of one or more MFIDs allocated and/or not allocated by the UE(s). For example, the UE(s) may transmit an indication of one or more model IDs allocated and/or not allocated by the UE and an indication of one or more functionality IDs allocated and/or not allocated by the UE together in a single message, or separately (e.g., via different messages). Similarly, in operation 204b, the network transmits a message to the UE(s). The message includes an indication of one or more MFIDs allocated and/or not allocated by the network. For example, the network may transmit an indication of one or more model IDs allocated and/or not allocated by the network and an indication of one or more functionality IDs allocated and/or not allocated by the network together in a single message, or separately (e.g., via different messages).

In some cases, one or more allocations of MFIDs by the UEs and/or the network may be rejected. In this case, in a fifth operation 205a, the UE(s) transmit(s) a message to the network. The message includes a rejection of the allocation of one or more MFIDs by the network. Similarly, in operation 205b, the network transmits a message to the UE(s). The message includes a rejection of the allocation of one or more MFIDs by the UE(s).

In an embodiment, the model IDs and/or the functionality IDs may be allocated by a specific ID management network entity (or a network node) to at least one of UE-side AI/ML models, UE-part of two-sided AI/ML models, network-side AI/ML models, and network-part of two-sided models. For example, such network entity may be included in a core network or in a RAN. This network entity may perform at least one of operations illustrated in FIG. 2.

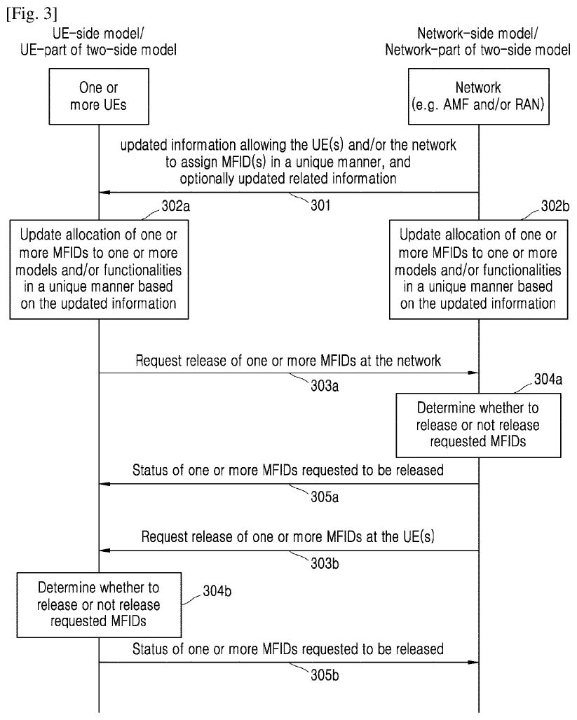

FIG. 3 is a second signal flow diagram illustrating further exemplary operations relating to managing one or more MFIDs.

In a first operation 301, the network (e.g. AMF entity, RAN entity such as a base station, and/or other network entity) transmits a message to one or more UEs. The message includes updated information allowing the UE(s) and/or the network to assign one or more MFIDs in a unique manner, and optionally updated related information (e.g. MFID type and/or MFID side information). For example, the information may comprise at least one of a list of updated allocated (assigned) model IDs and a list of updated not-allocated (non-assigned, or available) model IDs.

In a second operation 302a, the UE(s) update(s) the allocation of one or more MFIDs to one or more models and/or functionalities in a unique manner based on the updated information. Similarly, in operation 302b, the network updates the allocation of one or more MFIDs to one or more models and/or functionalities in a unique manner based on the updated information.

In a third operation 303a, the UE(s) transmit a message to the network. The message includes a request to release one or more MFIDs at the network.

In a fourth operation 304a, the network determines whether or not to release the requested MFIDs. The network may release some MFIDs and not release other MFIDs.

In a fifth operation 305a, the network transmits a message to the UE(s). The message includes information indicating a status (e.g. released, not released) of one or more MFIDs requested to be released.

Similarly, in operation 303a, the network transmits a message to the UE(s). The message includes a request to release one or more MFIDs at the UE(s).

In operation 304b, the UE(s) determine(s) whether or not to release the requested MFIDs. The UE(s) may release some MFIDs and not release other MFIDs.

In operation 305b, the UE(s) transmit(s) a message to the network. The message includes information indicating a status (e.g. released, not released) of one or more MFIDs requested to be released.

In an embodiment, the model IDs and/or the functionality IDs may be updated and/or released by a specific ID management network entity (or a network node) to at least one of UE-side AI/ML models, UE-part of two-sided AI/ML models, network-side AI/ML models, and network-part of two-sided models. For example, such network entity may be included in a core network or in a RAN. This network entity may perform at least one of operations illustrated in FIG. 3.

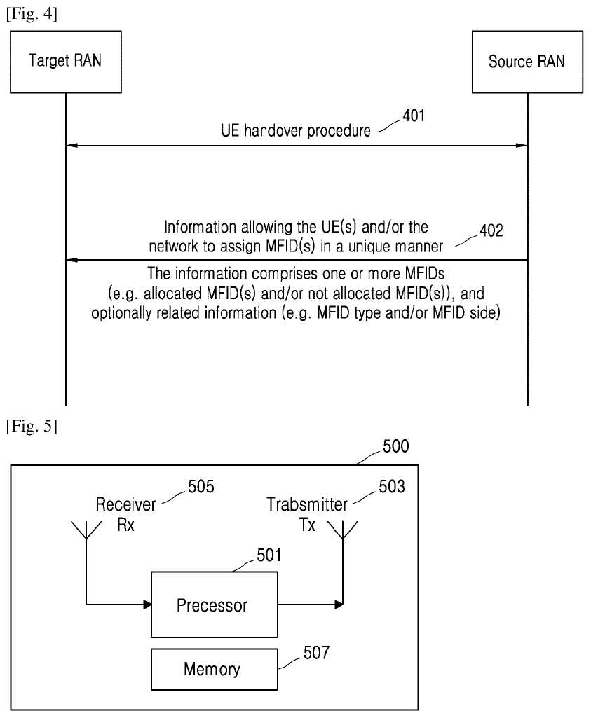

FIG. 4 is a third signal flow diagram illustrating a yet further exemplary operation relating to managing one or more MFIDs.

In a first operation 401, a UE handover procedure is carried out between a first RAN (e.g. a source RAN) and a second RAN (e.g. a target RAN). For example, the UE handover procedure is performed between a first RAN entity (e.g., a first base station) and a second RAN entity (e.g., a second base station).

In a second operation 402, the source RAN transmits a message to the target RAN. The message includes information for allowing one or more UEs and/or a network (e.g., the source RAN) to assign one or more MFIDs in a unique manner. The information includes one or more MFIDs (e.g. allocated MFID(s) and/or not allocated MFID(s)), and optionally related information (e.g. MFID type and/or MFID side information). In various examples, operation 402 may be considered as part of the handover procedure 401, or as separate from the handover procedure 401. For example, the source RAN entity may provide MFID(s) to the target RAN entity during the UE handover procedure. In various examples, the message may be transmitted via Xn interface (or signalling, or messages). In an embodiment, after the operation 401, the target RAN entity may transmit a message indicating that the UE handover procedure is completed to an AMF entity. In response to the handover completion message, the AMF entity may determine to (or not to) allocate, modify, release, and/or update one or more model IDs and/or one or more functionality IDs. The AMF entity may transmit (or provide) allocated, modified, released, and/or updated model IDs and/or functionality IDs to the target RAN entity.

The skilled person will appreciate that the operations shown in FIGS. 2-4 are merely examples that may be used in any suitable combination. In alternative examples, one or more of the operations shown in each of FIGS. 2-4 may be omitted and/or one or more further operations may be added. Also, the operations of FIGS. 2-4 may be used individually or may be combined with each other. The examples of FIG. 2-4 may incorporate, or be combined with, any of the other examples disclosed herein.

### Example Apparatus

FIG. 5 is a block diagram of an exemplary network entity that may be used in examples of the present disclosure. For example, a UE and/or network entity in the examples of FIGS. 1-4 may be provided in the form of the network entity of FIG. 5. The skilled person will appreciate that a network entity may be implemented, for example, as a network element on a dedicated hardware, as a software instance running on a dedicated hardware, and/or as a virtualised function instantiated on an appropriate platform, e.g. on a cloud infrastructure.

The entity 500 comprises a processor (or controller) 501, a transmitter 503 and a receiver 505. The receiver 505 is configured for receiving one or more messages from one or more other network entities, for example as described above. The transmitter 503 is configured for transmitting one or more messages to one or more other network entities, for example as described above. The processor 501 is configured for performing one or more operations, for example according to the operations as described above.

In an embodiment, the entity 500 may further comprise a memory 507. The memory 570 may store one or more model IDs and/or one or more functionality IDs which are already allocated to corresponding model or functionality, and/or not allocated to any models or functionalities. The memory 570 may store a computer program, one or more instructions, or a code to perform at least one operation illustrated in FIGS. 1 to 4.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the disclosure has been shown and described with reference to certain examples, it will be understood by those skilled in the art that various changes in form and detail may be made therein without departing from the scope of the disclosure, as defined by the appended claims.

### Abbreviations/Definitions

In the present disclosure, the following acronyms/definitions are used.
3GPP 3^{rd} Generation Partnership Project
5G 5^{th} Generation
6G 6^{th} Generation
AI Artificial Intelligence
AI/ML AI and/or ML
AMF Access and Mobility Management Function
eNB evolved Node B (e.g., Base Station)
FFS For Further Study
gNB 5G Base Station
ID Identity/Identifier
IE Information Element
LCM Life Cycle Management
MFID AI/ML Model and/or Functionality ID
ML Machine Learning
N2 Interface between NG-RAN and AMF
NAS Non Access Stratum
NB Base Station
NG Next Generation
NGAP NG Application Protocol
NR New Radio
NWDAF Network Data Analytics Function
OAM Operations, Administration and Maintenance
RAN Radio Access Network
RRC Radio Resource Control
SIB System Information Block
TS Technical Specification
UE User Equipment
Xn Interface between NG-RAN nodes

1. A method for managing, in a network, one or more artificial intelligence (AI) or machine learning (ML) model or functionality identities (MFIDs) for identifying at least one of one or more corresponding AI or ML models or AI or ML functionalities, the method comprising:
transmitting, by the network, to one or more user equipment (UEs), information for allowing at least one of the UE or the network to assign one or more MFIDs to at least one of one or more corresponding models or functionalities in a unique manner,
wherein the information comprises one or more MFIDs.

2. The method according to claim 1, wherein the information comprises one or more of:
a list of allocated MFIDs; and
a list of not allocated MFIDs.

3. The method according to claim 1, further comprising allocating, by the network or the UE, one or more MFIDs to at least one of one or more corresponding models or functionalities in a unique manner based on the information.

4. The method according to claim 3, wherein the allocating is performed at least partly by an Access and Mobility Management Function (AMF) entity.

5. The method according to claim 3, further comprising:
selecting, by the UE, one or more MFIDs based on the information; and
allocating the selected MFIDs to one or more models and/or functionalities.

6. The method according to claim 5, further comprising transmitting, by the UE, to the network, an indication of the at least one of MFIDs allocated by the UE or MFID not allocated by the UE.

7. The method according to claim 3, further comprising rejecting, by one of the network and the UE, the allocation of at least one of an MFID to a model or functionality by the other of the network and the UE.

8. The method according to claim 1, further comprising transmitting, by the network to a UE or by a UE to the network, information indicating support or lack of support for MFID type.

9. The method according to claim 1, further comprising storing at least one of the information or related information.

10. The method according to claim 1, further comprising transmitting, by a first RAN, to a second RAN, at least one of the information or related information.

11. The method according to claim 1, further comprising transmitting, by the network, to the one or more UEs, updated information for allowing at least one of the UE or the network to assign one or more MFIDs to at least one of one or more corresponding models or functionalities in a unique manner, wherein the updated information comprises one or more MFIDs.

12. The method according to claim 1, wherein the information is transmitted as part of one or more of:
a model transfer procedure;
a model delivery procedure; and
a model life cycle management (LCM) procedure.

13. The method according to claim 1, wherein one or more of the MFIDs are associated with a priority level.

14. The method according to claim 1, further comprising requesting, by the network or a UE, release of one or more MFIDs at the UE or the network.

15. A network entity configured to perform the method according to claim 1.
